(19) United States
(12) Patent Application Publication
(10) Pub. No.: US 2026/0047911 A1
(43) Pub. Date: Feb. 19, 2026

(54) ORTHODONTIC RETAINER FORMED OF PROPYLENE-BASED ELASTOMERS

(71) Applicant: RHE ORTHO ENTERPRISES LLC, Lake Worth, FL (US)

(72) Inventors: Manese Rabeony, Piscataway, NJ (US); Brad Markowitz, Cos Cob., CT (US); Jason Hirsch, Delray Beach, FL (US); Monroe Elkin, Lake Worth, FL (US)

(21) Appl. No.: 18/806,399

(22) Filed: Aug. 15, 2024

(51) Int. Cl. A61C 7/08; C08F 210/16; C08F 210/18; C08L 23/14

(52) U.S. Cl. CPC A61C 7/08; C08F 210/16; C08F 210/18; C08L 23/142; C08F 2800/20; C08L 2203/02; C08L 2203/30; C08L 2205/025

(57) ABSTRACT

A self-customizable orthodontic retainer comprising a body formed of a semi-crystalline propylene ethylene copolymer. The semi-crystalline propylene ethylene copolymer is a metallocene catalyzed copolymer having a crystallinity from about 2% to about 65% and a melt flow rate (MFR) of from about 2 g/10 min to about 50 g/10 min. The flow rate of the material allows the material to flow around the teeth and gums and into spaces between the teeth. After heating the retainer to a temperature in the range of about 60° C. to about 100° C., the body is a moldable material which crystalizes in the mouth at a temperature below 60° C. to conform the retainer to a contour of the mouth, gums, teeth and spaces between the teeth.

### BACKGROUND OF THE INVENTION

### Field of the Invention

The present invention relates to orthodontic retainers, and specifically to self-customizable orthodontic retainers.

### Description of Related Art

It is known that retainers have been used to maintain the dentition after completion of orthodontic treatment. Retainers are used to hold the teeth in position for a period of time, so that the periodontal fibers surrounding the teeth can adapt to the changes in the bone. This helps minimize any potential changes to the tooth position once orthodontic treatment is completed. Conventional retainers can be both fixed and removable.

The use of removable thermoformed plastic retainers has the capability to encapsulate and retain both posterior and anterior teeth. The need to maintain post treatment changes in the dentition is important. If retention is not maintained changes in occlusion are likely to occur. The retention phase generally exceeds the duration of the active treatment phase.

Upon completion of successful orthodontic treatment, the difficulty in maintaining the teeth in position requires the collaboration of both the orthodontist and the patient. The orthodontist provides the patient a proper fitting and comfortable retainer. The responsibility of the patient is to faithfully wear the retainer as instructed. The retention phase is paramount to the overall success of the orthodontic treatment.

Conventional removable retainers have been formed of acrylic with metal wire. Conventional removable retainers have also been vacuum-formed. Vacuum formed retainers have been formed of a polypropylene or copolyester material. Vacuum-formed retainers (VFRs) have been made of clear thermoplastic material, heated, and formed on a patient's plaster model in a vacuum machine. Vacuum-formed retainers have advantages for patients due to their appearance, comfort, and superior aesthetics. Fixed/Bonded retainers which are not removable are also known. Fixed/bonded retainers have used metal wire of stainless steel, nickel, or titanium.

U.S. Pat. No. 5,692,894 describes a thermoformed plastic dental retainer and method of selectively straightening crooked or maloccluded teeth and retaining the straightened teeth using the retainer. The dental retainer is constructed by first forming an impression of a patient's upper or lower dentition and constructing a cast from the impression. The retainer is vacuum thermoformed over the cast using a sheet, plate or disc of thermoformable plastic and a vacuum or pressure thermoforming machine.

U.S. Patent Publication No. 2022/0233276 describes an orthodontic dental appliance includes a polymeric shell with a plurality of cavities for receiving one or more teeth. The orthodontic dental appliance is directed to a multi-layered dental appliance such as, for example, an orthodontic aligner tray or retainer tray, that includes multiple layers of high flexural modulus and low flexural modulus polymeric materials to improve patient comfort while maintaining an acceptable level of force persistence. The multi-layered dental appliance is formed from a film including an interior region with a core layer of a first thermoplastic polymer A with a thermal transition temperature of about 70° C. to about 140° C. in and a flexural modulus greater than about 1.3 GPa, and first and second interior layers of a second thermoplastic polymer B with a glass transition temperature of less than about 0° C. and a flexural modulus less than about 1 GPa; and first and second exterior layers of a third thermoplastic polymer C with a thermal transition temperature of about 70° C. to about 140° C. and a flexural modulus greater than about 1.3 GPa. Interfacial adhesion between any of the adjacent layers in the polymeric shell is greater than about 150 grams per inch. The film is subsequently thermal formed against a mold.

Removable retainers have the shortcoming that they are prone to relapse due to the negligence of the patient not wearing the retainers or losing the retainers. Conventional removable retainers require laboratory fabrication and are expensive to manufacture. Similarly, removable retainers which are vacuum-formed are expensive to manufacture by requiring costly equipment, an impression and a stone model of the teeth. The labial bow which is made of stainless-steel wire is aesthetically inferior to transparent retainers. Fixed/Bonded retainers have the shortcoming of tending to accumulate plaque and calculus leading to compromised oral hygiene and possible periodontal disease. Fixed/Bonded retainers are technique sensitive to place by the orthodontist. The Fixed/Bonded retainers must be isolated so that they are free of moisture. In the absence of proper isolation, the distortion of the wire during curing, inadequate adhesive and or setting time failure is common. It is also difficult to repair any damaged fixed wires. Attempts to correct a fixed retainer that has been damaged can lead to another failure.

A removable retainer consisting of a rubber plate covering the mucosa with perforations to accommodate the teeth has been described in Kingsley N W. Chapter 4: Physiology and pathology. 1st ed. pp 57-67. New York: Appleton & Co, 1880). Observations of the removable retainer described by Kingsley include that after malpositioned teeth have been moved into the desired position, they must be mechanically supported until all the tissues involved in their support and maintenance in their new positions shall have become thoroughly modified, both in structure and in function to meet the new requirements, as described in Angle E H. Chapter 12: Retention. In Treatment of malocclusion of the teeth and fractures of the maxillac. 6th ed. pp 150-166. Philadelphia: The SS White Dental Manufacturing Company, 1900.

The use of a lingual bar banded from cuspid to cuspid might lead to decalcification of the dentition if left in place for long periods of time and is of poor aesthetics. Directly bonded canine and -canine retainers might be useful for routine retention in orthodontics. The main advantage of a bonded retainer as compared to the banded retainer was its aesthetic superiority. This also presents a problem with maintaining good oral hygiene in the area of the bonded retainer.

There is a need for an orthodontic retainer of a custom-fit without the need to have it formed by a dentist or dental laboratory. There is a need for an orthodontic retainer without the need for an impression or a digital scan of the teeth. There is a need for a self-customizable, orthodontic retainer, which is esthetic and durable while it offers stability for the teeth, has no odor and does not distort or deform.

### BRIEF SUMMARY OF THE INVENTION

The present invention relates to a self-customizable orthodontic retainer comprising a body formed of a semi-crystalline propylene ethylene copolymer. The semi-crystalline propylene ethylene copolymer is a metallocene catalyzed copolymer having a crystallinity of about 2% to about 65% and a melt flow rate (MFR) of about 2 g/10 min to about 50 g/10 min. The melt flow rate of the material allows the material to flow around the teeth and gums and into spaces between the teeth. After heating the retainer to a temperature in the range of about 60° C. to about 100° C., the body is a moldable material which crystalizes in the mouth at a temperature below 60° C. to conform the retainer to a contour of the mouth, gums, teeth and spaces between the teeth. The retainer is self-customized to securely fit to the gums, teeth and spaces between the teeth and prevent relapse of the teeth.

The self-customizable orthodontic retainer of the present invention exhibits strong tensile strength, exceptional durability, flexibility, and has little or no odor. The self-customizable orthodontic retainer of the present invention can be made clear, flavored, or colored for identification. The self-customizable orthodontic retainer of the present invention is nonhazardous. The self-customizable orthodontic retainer of the present invention can be easily molded by the user of the orthodontic retainer. The self-customizable orthodontic retainer has the advantages of (a) giving the user ample time, for example, 2 to 3 minutes, to properly fit the orthodontic retainer at a workable temperature below 60° C., during which the material must remain soft and elastic/extensible to conform the contour of the mouth, teeth and spaces between the teeth; (b) providing shrink without any distortion or deformation once the retainer is comfortably in place; and (c) possessing a good balance of hardness, stiffness, and soft feel.

In some embodiments, the self-customizable orthodontic retainer of the present invention can be adapted to be reformed by reheating to a temperature of about 60° C. to about 100° C.

The invention will be more fully described by reference to the following drawings.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1 is a perspective view of a retainer in accordance with the teachings of the present invention; and

FIG. 2 is a perspective view of the retainer after molding to the teeth.

### DETAILED DESCRIPTION OF THE INVENTION

Reference will now be made in greater detail to a preferred embodiment of the invention, an example of which is illustrated in the accompanying drawings. Wherever possible, the same reference numerals will be used throughout the drawings and the description to refer to the same or like parts.

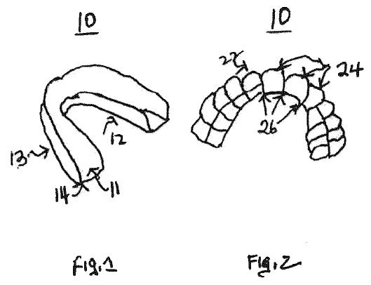

FIGS. 1 and 2 illustrate orthodontic retainer 10 in accordance with the teachings of the present invention. Orthodontic retainer 10 is formed of body 13. Body 13 includes channel 11 being formed of walls 12 upstanding on either side of base 14. Walls 12 having a height in a range of about 10 mm to about 20 mm. A thickness of walls 12 and base 14 being in a range of about 1 mm to about 2 mm.

Orthodontic retainer 10 is formed of a material which is customizable by a user of retainer 10. The melt flow rate of the material allows the material to flow around the teeth and gums and into spaces between the teeth. After molding, orthodontic retainer 10 conforms to a contour of mouth 20, gums 22, teeth 24 and spaces between teeth 26 as shown in FIG. 2. Orthodontic retainer 10 can be formed of a propylene-based elastomer. The propylene-based elastomer can be a copolymer of propylene-derived units and units derived from at least one of ethylene or a C₄-C₁₀ alpha-olefin. The propylene-based elastomer may contain at least about 50 wt % propylene-derived units as described in U.S. Pat. No. 9,382,412 hereby incorporated by reference into this application. The propylene-based elastomer may have limited crystallinity due to adjacent isotactic propylene units and a melting point as described herein. The crystallinity and the melting point of the propylene-based elastomer can be reduced compared to highly isotactic polypropylene by the introduction of errors in the insertion of propylene. The propylene-based elastomer is generally devoid of any substantial intermolecular heterogeneity in tacticity and comonomer composition, and also generally devoid of any substantial heterogeneity in intramolecular composition distribution.

The amount of propylene-derived units present in the propylene-based copolymer can range from an upper limit of about 95 wt %, about 94 wt %, about 92 wt %, about 90 wt %, or about 85 wt %, to a lower limit of about 55 wt %, 60 wt %, about 65 wt %, about 70 wt %, about 75 wt %, about 80 wt %, about 84 wt %, or about 85 wt % of the propylene-based elastomer.

The units, or comonomers, derived from at least one of ethylene or a C₄-C₁₀ alpha-olefin may be present in an amount of about 1 to about 35 wt %, or about 5 to about 35 wt %, or about 7 to about 32 wt %, or about 5% to 25% wt %, or about 8 to about 25 wt %, or about 8 to about 20 wt %, or about 8 to about 18 wt %, of the propylene-based copolymer. The comonomer content may be adjusted so that the propylene-based elastomer has a heat of fusion of less than about 80 J/g, a melting point of about 105° C. or less, and a crystallinity of about 2% to about 65% of the crystallinity of isotactic polypropylene, and a melt flow rate (MFR) of about 2 to about 50 g/min. In one embodiment the melt flow rate (MFR) is about 8 to about 45 g/10 min.

In preferred embodiments, the comonomer is ethylene, 1-hexene, or 1-octene, with ethylene being most preferred. In embodiments where the propylene-based copolymer comprises ethylene-derived units, the propylene ethylene copolymer can comprise about 5 to about 25 wt %, or about 8 to about 20 wt %, or about 9 to about 16 wt %, ethylene-derived units. The copolymer can comprise about 5 to 25% by weight of ethylene-derived units and about 55 to 95% by weight of propylene derived units. The semi-crystalline propylene ethylene copolymer is formed by copolymerizing propylene ethylene copolymer. A first polymer component comprising isotactic polypropylene and having a melting point greater than about 110° C., and copolymerizing propylene and ethylene using a chiral metallocene catalyst system, the copolymer having crystallinity from about 2% to about 65% from isotactic polypropylene sequences, a melting point of from 50° C. to 105° C., and wherein a glass transition temperature of the second polymer component of ethylene is retained in the polymer.

In some embodiments, the propylene-based elastomer consists essentially of units derived from propylene and ethylene, i.e., the propylene-based elastomer does not contain any other comonomer in an amount other than that typically present as impurities in the ethylene and/or propylene feed streams used during polymerization, or in an amount that would materially affect the heat of fusion, melting point, crystallinity, or melt flow rate of the propylene-based elastomer, or in an amount such that any other comonomer is intentionally added to the polymerization process.

In some embodiments, the propylene-based elastomer can comprise more than one comonomer. Preferred embodiments of a propylene-based elastomer having more than one comonomer include propylene-ethylene-octene, propylene-ethylene-hexene, and propylene-ethylene-butene polymers. In embodiments where more than one comonomer derived from at least one of ethylene or a C4-C10 alpha-olefin is present, the amount of one comonomer may be less than about 5 wt % of the propylene-based elastomer, but the combined amount of comonomers of the propylene-based elastomer is about 5 wt % or greater.

The propylene-based elastomer may have a triad tacticity of three propylene units, as measured by 13C NMR, of at least about 75%, at least about 80%, at least about 82%, at least about 85%, or at least about 90%. Preferably, the propylene-based elastomer has a triad tacticity of about 50 to about 99%, or about 60 to about 99%, or about 75 to about 99%, or about 80 to about 99%. In some embodiments, the propylene-based elastomer may have a triad tacticity of about 60 to 97%.

The propylene-based elastomer has a heat of fusion (“Hf”), as determined by DSC, of about 80 J/g or less, or about 70 J/g or less, or about 50 J/g or less, or about 40 J/g or less. The propylene-based elastomer may have a lower limit Hf of about 0.5 J/g, or about 1 J/g, or about 5 J/g. For example, the Hf value may range from about 1.0, 1.5, 3.0, 4.0, 6.0, or 7.0 J/g, to about 30, 35, 40, 50, 60, 70, 75, or 80 J/g.

The propylene-based elastomer can have a percent crystallinity, as determined according to the DSC procedure described herein, of about 0.5 to about 65%, or about 0.5 to about 40%, or about 1 to about 30%, or about 5 to about 35%, or about 2 to about 65% of the crystallinity of isotactic polypropylene. The thermal energy for the highest order of propylene (i.e., 100% crystallinity) is estimated at 189 J/g. In some embodiments, the copolymer has crystallinity less than 40%, or in the range of about 0.25 to about 25%, or in the range of about 0.5 to about 22% of the crystallinity of isotactic polypropylene.

Embodiments of the propylene-based elastomer may have a tacticity index m/r from a lower limit of about 4, or about 6, to an upper limit of about 8, or about 10, or about 12. In some embodiments, the propylene-based elastomer has an isotacticity index greater than 0%, or within the range having an upper limit of about 50%, or about 25%, and a lower limit of about 3%, or about 10%.

In some embodiments, the propylene-based elastomer can further comprise diene-derived units (as used herein, “diene”). The optional diene may be any hydrocarbon structure having at least two unsaturated bonds wherein at least one of the unsaturated bonds is readily incorporated into a polymer. For example, the optional diene may be selected from straight chain acyclic olefins, such as 1,4-hexadiene and 1,6-octadiene; branched chain acyclic olefins, such as 5-methyl-1,4-hexadiene, 3,7-dimethyl-1,6-octadiene, and 3,7-dimethyl-1,7-octadiene; single ring alicyclic olefins, such as 1,4-cyclohexadiene, 1,5-cyclooctadiene, and 1,7-cyclododecadiene; multi-ring alicyclic fused and bridged ring olefins, such as tetrahydroindene, norbornadiene, methyl-tetrahydroindene, dicyclopentadiene, bicyclo-(2.2.1)-hepta-2,5-diene, norbornadiene, alkenyl norbornenes, alkylidene norbornenes, e.g., ethylidene norbornene (“ENB”), cycloalkenyl norbornenes, and cycloalkylidene norbornenes (such as 5-methylene-2-norbornene, 5-ethylidene-2-norbornene, 5-propenyl-2-norbornene, 5-isopropylidene-2-norbornene, 5-(4-cyclopentenyl)-2-norbornene, 5-cyclohexylidene-2-norbornene, 5-vinyl-2-norbornene); and cycloalkenyl-substituted alkenes, such as vinyl cyclohexene, allyl cyclohexene, vinyl cyclooctene, 4-vinyl cyclohexene, allyl cyclodecene, vinyl cyclododecene, and tetracyclo (A-11,12)-5,8-dodecene. The amount of diene-derived units present in the propylene-based elastomer may range from an upper limit of about 15%, about 10%, about 7%, about 5%, about 4.5%, about 3%, about 2.5%, or about 1.5%, to a lower limit of about 0%, about 0.1%, about 0.2%, about 0.3%, about 0.5%, about 1%, about 3%, or about 5%, based on the total weight of the propylene-based elastomer.

The propylene-based elastomer can have a single peak melting transition as determined by DSC. In some embodiments, the copolymer has a primary peak transition of about 90° C. or less, with a broad end-of-melt transition of about 110° C. or greater. The peak “melting point” (“Tm”) is defined as the temperature of the greatest heat absorption within the range of melting of the sample. The copolymer may show secondary melting peaks adjacent to the principal peak, and/or at the end-of-melt transition. For the purposes of this disclosure, such secondary melting peaks are considered together as a single melting point, with the highest of these peaks being considered the Tm of the propylene-based elastomer. The propylene-based copolymer may have a Tm of about 110° C. or less, about 105° C. or less, about 100° C. or less, about 90° C. or less, about 80° C. or less, or about 70° C. or less. In some embodiments, the propylene-based elastomer has a Tm of about 25 to about 105° C., or about 60 to about 105° C., or about 70 to about 105° C., or about 90 to about 105° C.

The propylene-based elastomer may have a density of about 0.850 to about 0.900 g/cm3, or about 0.860 to about 0.880 g/cm³, at room temperature as measured per ASTM D1505.

The propylene-based elastomer or propylene ethylene copolymer can have a melt flow rate (“MFR”), as measured per ASTM D1238, 2.16 kg at 230° C. of at least about 2 g/10 min. In some embodiments, the propylene-based elastomer can have an MFR of about 2 to about 50 g/10 min, or about 3 g/10 min to about 45 g/10 min or about 3 to about 10 g/10 min, or about 3 to about 8 g/10 min.

The propylene-based elastomer may have an Elongation at Break of less than about 2000%, less than about 1800%, less than about 1500%, less than about 1000%, or less than about 800%, as measured per ASTM D412.

The propylene-based elastomer may have a weight average molecular weight (MW) of about 5,000 to about 5,000,000 g/mole, or about 10,000 to about 1,000,000 g/mole, or about 50,000 to about 400,000 g/mole. The propylene-based elastomer may have a number average molecular weight (Mn) of about 2,500 to about 250,000 g/mole, or about 10,000 to about 250,000 g/mole, or about 25,000 to about 250,000 g/mole. The propylene-based elastomer may have a z-average molecular weight (Mz) of about 10,000 to about 7,000,000 g/mole, or about 80,000 to about 700,000 g/mole, or about 100,000 to about 500,000 g/mole.

The propylene-based elastomer may have a molecular weight distribution (“MWD”) of about 1.5 to about 20, or about 1.5 to about 15, or about 1.5 to about 5, or about 1.8 to about 3, or about 1.8 to about 2.5.

In some embodiments, the propylene-based elastomer is an elastomer including propylene-crystallinity, a melting point by DSC equal to or less than 105° C., and a heat of fusion of from about 5 J/g to about 45 J/g. The propylene-derived units are present in an amount of about 80 to about 90 wt %, based on the total weight of the propylene-based elastomer. The ethylene-derived units are present in an amount of about 8 to about 18 wt %, for example, about 8, about 8.5, about 9, about 9.5, about 10, about 10.5, about 11, about 11.5, about 12, about 12.5, about 13, about 13.5, about 14, about 14.5, about 15, about 15.5, about 16, about 16.5, about 17, about 17.5, about 18 wt %, based on the total weight of the propylene-based elastomer.

The compositions disclosed herein can include one or more different propylene-based elastomers, i.e., propylene-based elastomers each having one or more different properties such as, for example, different comonomer or comonomer content. Such combinations of various propylene-based elastomers are all within the scope of the invention.

The propylene-based elastomer can comprise copolymers prepared according to the procedures described in WO 02/36651, U.S. Pat. No. 6,992,158, and/or WO 00/01745 each of which is hereby each incorporated by reference. Preferred methods for producing the propylene-based elastomer may be found in U.S. Pat. Nos. 7,232,871 and 6,881,800 each of which is hereby each incorporated by reference hereby incorporated by reference. The invention is not limited by any particular polymerization method for preparing the propylene-based elastomer, and the polymerization processes are not limited by any particular type of reaction vessel.

Suitable propylene-based elastomers which can be used to form retainer 12 are available commercially under the trade names VISTAMAXX™ (ExxonMobil Chemical Company, Houston, Tex., USA), VERSIFY™ (The Dow Chemical Company, Midland, Mich., USA), certain grades of TAFMER™ XM or NOTIO™ (Mitsui Company, Japan), and certain grades of SOFTEL™ (Basell Polyolefins of the Netherlands). The properties of these copolymers are derived from the controlled level of the propylene crystallinity, enabled by Exxpol® metallocene catalyst technology which provides 3 to 30 percent crystallinity. One or more grades of VISTAMAXX™ can be used to form body 13 of orthodontic retainer 10. The particular grade(s) of commercially available propylene-based elastomer suitable for use in the invention can be readily determined using methods commonly known in the art.

The material was tested for tensile strength, elongation, hardness, biocompatibility, impact strength and water absorption using specimens and tests described by the American Society for Testing and Materials Standards.

In some embodiments, orthodontic retainer 10 can be formed of a blend or laminates of materials with the polypropylene ethylene copolymer. The blend can comprise polymers elastomers, crystalline, rubber which are mixed with the propylene ethylene copolymer in order to change and/or enhance various properties of the co-polymer. For example, the addition of an elastomer, which is a polymer with viscoelasticity, can increase the case with which the moldable part is molded to the anatomy of the user. In one embodiment, various grades of Vistamaxx™ are blended together to form the blended material for orthodontic retainer 10.

In one embodiment, orthodontic retainer 10 is formed of a blend of a propylene ethylene copolymer having a lower melt mass flow rate (MFR) in the range of about 2 g/10 min to about 10 g/10 min and a higher melt mass flow rate (MFR) in the range of about 20 g/10 min to about 50 g/10 min. In one embodiment, orthodontic retainer 10 is formed of a blend of about 70% to 95% by weight of a propylene ethylene copolymer having a lower melt mass flow rate (MFR) in the range of about 2 g/10 min to about 10 g/10 min and about 5% to 30% by weight of a propylene ethylene copolymer having a higher melt mass flow rate (MFR) in the range of about 20 g/10 min to about 50 g/10 min.

In some embodiments, orthodontic retainer 10 is formed of two laminated separate components. The laminate can have a harder outer layer component and a softer inner component. The harder outer layer with a melt mass flow rate (MFR) in the range of about 8 g/10 min to about 50 g/10 min keeps the retainer rigid while the softer inner layer with a melt mass flow rate (MFR) in the range of about 8 g/10 min to about 50 g/10 min provides comfort.

The material crystallizes slowly after being heated such that the user has the opportunity to form a true custom-fit to the mouth, gums, teeth and spacing between the teeth after heating the material, such as for example in hot water or in a microwave. During this time interval, the material remains soft and extensible. At time interval for fitting of orthodontic retainer 10 is 2-3 minutes. As the material cools, the material of the orthodontic retainer 10 allows the retainer to shrink, giving a snug fit with to every detail of the mouth, including the gums, teeth and spacing between the teeth. The material flows and crystallizes in a way that allows it to conform to the teeth, spaces between the teeth, gums, and soft tissues of the mouth, resulting in an orthodontic retainer that has the functionality previously present in a conventional retainer formed by a dentist and/or laboratory.

Suitable polymer blends comprise a composition formed of an isotactic polypropylene component and an alpha olefin-propylene copolymer, the copolymer comprising crystallizable propylene sequences. The composition can be formed by blending at least a first polymer component and a second polymer component, the blend comprising from about 2% to about 95% by weight of the first polymer component, the first polymer component comprising isotactic polypropylene and having a melting point greater than about 110° C., and copolymerizing propylene and ethylene using a chiral metallocene catalyst system, the copolymer having crystallinity from about 2% to about 65% from isotactic polypropylene sequences, a propylene content of from about 75% to about 90% by weight, a melting point of from 50° C. to 105° C., and wherein a glass transition temperature of the second polymer component is retained in the polymer blend. Alternatively, the polymer blend can be an uncross linked blend composition comprising a dispersed phase of a crystalline polymer component in a continuous phase of a crystallizable polymer component wherein: a) the crystalline polymer component is dispersed in phases less than 3 μm×3 μm×100 μm in size, b) the blend composition has greater than 65% propylene units by weight, c) the blend comprises greater than 1% but less than 40% by weight is based on the total weight of the blend of a crystalline first polymer component and less than 99% but greater than 60% by weight based on the total weight of the blend of a crystallizable second polymer component, such crystallinity being due to stereoregular polymerized propylene units, d) both first and second polymer component contain stereoregular polymerized propylene units of identical tacticity, e) the blend has a tensile elongation greater than 650%, wherein the first polymer component is a propylene homopolymer and has a melting point by DSC equal to or above 115° C., and the second polymer component is a copolymer of the propylene units and from about 8% to about 25% by weight ethylene units and has a melting point equal to or less than about 100° C.

Colorants can be added to the propylene ethylene copolymer to achieve a suitable aesthetic appearance. For example, the colorants can be clear. A suitable colorant is sold by Milliken Chemical under the trade designation CLEARTINT™ (Milliken Chemical Division of Milliken & Company (Spartanburg, S.C.)). Light reflective material can also be added or attached to the propylene ethylene copolymer to achieve additional aesthetic appearance. In some embodiments, additional additive/filler such as for example, SiO₂ or carbon nanotubes can be mixed with the propylene ethylene in order to change and/or enhance various properties of the co-polymer. For example, the addition of an elastomer, which is a polymer with viscoelasticity, can increase the case with which the moldable part is molded to the mouth of the user.

A method of forming a self-customizable orthodontic retainer comprises the steps of placing the orthodontic retainer 10 in a hot medium. For example, the user places the orthodontic retainer 10 into a hot liquid, for example, orthodontic retainer 10 can be placed into water having a temperature of about 60° C. to about 100° C. for a few seconds. Orthodontic retainer 10 is then removed and cooled for 3-5 seconds and then self-customized to the user's mouth, teeth, spaces between the teeth and gums to provide a custom fit. Alternatively, orthodontic retainer 10 can be placed in a wet paper towel and heated in a microwave oven. For example, orthodontic retainer 10 can be heated in one example, for about 35 to 40 seconds in a microwave on a high setting. Orthodontic retainer 10 can be cooled for a short period of time, for example about 5 seconds. After placing orthodontic retainer 10 in the mouth for customizing, orthodontic retainer 10 can be left in the mouth until comfortable or placed in cold water for two minutes and returned to the mouth.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

### Example 1

In an example, the composition of the retainer may include two or more grades of Vistamaxx™ blended at varying percentages in order to achieve a desired level of hardness and stiffness. Vistamaxx™ 3980 and Vistamaxx™ 6502 may be combined to achieve a desired hardness and stiffness. Table 1 lists grades of Vistamaxx™ that may be used in the retainer. According to this example, the composition of the blend may range between 0-99% wt. Vistamaxx™ 3980, between 0-99% wt. Vistamaxx™ 6502.

TABLE 1

| | | Visca Softening | | Melt |
|---|---|---|---|---|
| | Ethylene | point | Flexural | Mass-Flow |
| Grade | content | ASTM D 1525 | modulus - 1% | Rate (MFR) |
| Name | (weight %) | ° C.(° F.) | Secant (psi) | (g/10 min |
| 3980 | 9 | 77.3(171) | 17000 | 8 |
| 3000 | 11 | 65.0(149) | 9000 | 8 |
| 6502 | 13 | 51.5(125) | 3000 | 45 |
| 6102 | 16 | 53.3(129) | 2100 | 3 |

Table 2 lists various properties of retainer according to Table 1.

TABLE 2

| Physical and Mechanical Properties | Retainer |
|---|---|
| Biocompatibility | Biocompatible |
| Water sorption (wt %) | No water sorption (hydrophobic) |
| Density, g/cc | 0.86-0.89 |
| Melting Point ° C. | 55-80 |
| Tensile Strength (MPa) | 15-30 |
| Die C Tear Strength (lbf/in) | 130-330 |
| Elongation at Break (%) | 100-1500 |
| Flexural Modulus (MPa) | 10-40 |
| Fitting time before composition hardens | 2-3 minutes |
| Shrinkage and adaptation to teeth | Excellent |

### Example 2

In an example, the composition of the retainer may include a laminate of two or more grades of Vistamaxx™ to achieve a desired hardness and stiffness. The hard outer layer is formed of Vistamaxx™ 3980FL and a soft inner layer is formed of Vistamaxx™ 6502).

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A self-customizable orthodontic retainer comprising:
a body, said body being formed of a semi-crystalline propylene ethylene copolymer having crystallinity from about 0.5% to about 65% and a melt flow rate from about 2 g/10 min to about 50 g/min wherein after heating the retainer to a temperature in a range of about 60° C. to about 100° C. the body forms a moldable material, the moldable material crystalizes in the mouth at a temperature below 60° C. to conform the retainer to a contour of the mouth, gums, teeth and spaces between the teeth, wherein the retainer is self-customized to securely fit to the gums, teeth and spaces between the teeth.

2. The self-customizable orthodontic retainer according to claim 1, wherein the propylene ethylene copolymer comprising about 1% to about 35% by weight of ethylene and about 55% to about 95% by weight of propylene, wherein said semi-crystalline propylene ethylene copolymer is formed by copolymerizing propylene and ethylene using a chiral metallocene catalyst system.

3. The self-customizable orthodontic retainer according to claim 2 wherein the propylene ethylene copolymer comprising about 5% to about 25% by weight of ethylene.

4. The self-customizable orthodontic retainer according to claim 1 wherein the crystallinity being from about 2.0% to about 65%.

5. The self-customizable orthodontic retainer according to claim 1 wherein the propylene ethylene copolymer is a blend of about 70% to 95% by weight of a propylene ethylene copolymer having a melt mass flow rate (MFR) in the range of about 2 g/10 min to about 10 g/10 min and about 5% to 30% by weight of a propylene ethylene copolymer having a melt mass flow rate (MFR) in the range of about 20 g/10 min to about 50 g/10 min or a laminate of a first layer of a propylene ethylene copolymer having a melt mass flow rate (MFR) in the range of about 2 g/10 min to about 10 g/10 min and a second layer of a propylene ethylene copolymer having a melt mass flow rate (MFR) in the range of about 20 g/10 min to about 50 g/10 min.

6. The self-customizable orthodontic retainer according to claim 1 further comprising one or more of octene, hexene, and butene comonomers.

7. The self-customizable orthodontic retainer according to claim 1 further comprising diene-derived units present in the propylene ethylene copolymer in an amount of 1% to about 15% based on the total weight of the propylene ethylene copolymer.

8. The self-customizable orthodontic retainer according to claim 1 wherein the semi-crystalline propylene ethylene copolymer has a melting point by DSC equal to or less than 105° C. and a heat of fusion of from about 5 J/g to about 45 J/g.

9. The self-customizable orthodontic retainer according to claim 1, wherein said body is channel, the channel being formed of walls upstanding on either side of a base, the walls having a height in the range of about 10 to about 20 mm and a thickness of the walls and the base in the range of about 1 to about 2 mm.

10. The self-customizable orthodontic retainer according to claim 1 further comprising a colorant added to the semi-crystalline propylene ethylene copolymer.

11. The self-customizable orthodontic retainer according to claim 1 wherein the colorant is clear or a color.

12. The self-customizable orthodontic retainer according to claim 1 wherein the body remains moldable for about 2 to 3 minutes as the temperature falls below 60° C. following heating.

13. The self-customizable orthodontic retainer according claim 1 wherein the self-customizable orthodontic retainer is adapted to be reformed by reheating to a temperature of about 60° C. to about 100° C.

14. A method of customizing a orthodontic retainer to a mouth of a user, the method including:
obtaining a body, wherein the body includes a semi-crystalline propylene ethylene copolymer having crystallinity from about 0.5% to about 65% and a melt flow rate from about 2 g/10 min to about 50 g/10 min:
heating the body, to a temperature of about 60° C. to about 100° C.;
applying the body to the mouth of the user; and
setting the body in the mouth to a temperature below 60° C. to conform the body to a contour of the mouth, gums, teeth and spaces between the teeth.

15. The method of claim 14 wherein the propylene ethylene copolymer comprising about 5% to about 25% by weight of ethylene and about 55% to about 95% by weight of propylene, wherein said semi-crystalline propylene ethylene copolymer is formed by copolymerizing propylene and ethylene using a chiral metallocene catalyst system.

16. The method of claim 15 wherein the crystallinity being from about 2.0% to about 65%.

17. The method of claim of claim 16 wherein the propylene ethylene copolymer is a blend of about 70% to 95% by weight of a propylene ethylene copolymer having a melt mass flow rate (MFR) in the range of about 2 g/10 min to about 10 g/10 min and about 5% to 30% by weight of a propylene ethylene copolymer having a melt mass flow rate (MFR) in the range of about 20 g/10 min to about 50 g/10 min or a laminate of a first layer of a propylene ethylene copolymer having a melt mass flow rate (MFR) in the range of about 2 g/10 min to about 10 g/10 min and a second layer of a propylene ethylene copolymer having a melt mass flow rate (MFR) in the range of about 20 g/10 min to about 50 g/10 min.

18. The method of claim 16 further comprising the steps of:
reheating the body to a temperature of about 60° C. to about 100° C. to form a reformable body;
applying the reformable body to the mouth of the user; and
setting the reformable body in the mouth to a temperature below 60° C. to conform the reformable body to a contour of the mouth, gums, teeth and spaces between the teeth.

19. A self-customizable orthodontic retainer comprising:
a body, said body being formed of a semi-crystalline propylene C₄-C₁₀ alpha-olefin copolymer having crystallinity from about 0.5% to about 65% and a melt flow rate from about 2 g/10 min to about 50 g/min wherein after heating the retainer to a temperature in a range of about 60° C. to about 100° C. the body forms a moldable material, the moldable material crystalizes in the mouth at a temperature below 60° C. to conform the retainer to a contour of the mouth, gums, teeth and spaces between the teeth, wherein the retainer is self-customized to securely fit to the gums, teeth and spaces between the teeth.

20. The self-customizable orthodontic retainer of claim 19 wherein the propylene C₄-C₁₀ alpha-olefin copolymer is a blend of about 70% to 95% by weight of a propylene C₄-C₁₀ copolymer having a melt mass flow rate (MFR) in the range of about 2 g/10 min to about 10 g/10 min and about 5% to 30% by weight of a propylene C₄-C₁₀ copolymer having a melt mass flow rate (MFR) in the range of about 20 g/10 min to about 50 g/10 min.
